(19) United States
(12) Patent Application Publication
(10) Pub. No.: US 2019/0173116 A1
(43) Pub. Date: Jun. 6, 2019

(54) MEMBRANELESS DIRECT-TYPE FUEL CELLS

(71) Applicants: RHODIA OPERATIONS, Paris (FR); FUDAN UNIVERSITY, Yangpu District, Shanghai (CN)

(72) Inventors: Mengjia WU, Shanghai (CN); Pascal METIVIER, Shanghai (CN); Yongyao XIA, Shanghai (CN)

(21) Appl. No.: 16/323,300

(22) PCT Filed: Aug. 5, 2016
(86) PCT No.: PCT/CN2016/093558

§ 371 Date: Feb. 5, 2019

(51) Int. Cl. H01M 8/18; H01M 8/22; H01M 8/1034; H01M 8/1032; H01M 8/103

(52) U.S. Cl. CPC H01M 8/18; H01M 8/222; H01M 8/103; H01M 8/1032; H01M 8/1034

(57) ABSTRACT

The present invention relates to a membraneless direct-type fuel cell, which directly uses oxidizable phosphorus compound, sulphur compound or nitrogen compound as fuel.

The present invention relates to a membraneless direct-type fuel cell, which directly uses oxidizable phosphorus compound, sulphur compound or nitrogen compound as fuel.

### PRIOR ART

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

Fuel cells are a family of sustainable energy technologies that generate electricity through electrochemical processes, rather than combustion. There are many fuel cell types, but the principal ones include alkaline fuel cells (AFCs), proton exchange membrane fuel cells (PEMFCs), direct methanol fuel cells (DMFCs), molten carbonate fuel cells (MCFCs), phosphoric acid fuel cells (PAFCs), and solid oxide fuel cells (SOFCs). Different fuel cells are applied in different ways owning to their specific operating characteristics. For example, the commercial use of AFCs is very limited and it is normally used in controlled aerospace and underwater environments because of its sensitiveness to carbon dioxide. The operating temperature of MCFCs and SOFCs is higher than other types of fuel cells, and therefore they are more suitable for large stationary applications. Direct-type fuel cells (DFCs) are widely used not only for stationary power plant but also for commercial fuel cell vehicles and typical temperature for that application is 80° C. Direct methanol fuel cell (DMFCs), which are one classical type among direct type fuel cells, are specifically ideal for miniature applications at room temperature, such as cell phones and laptops. PAFCs are a type of fuel cell that uses liquid phosphoric acid as an electrolyte, which require higher loadings of expensive platinum catalyst than other types of fuel cells.

Since the commercial use of the above mentioned fuel cells will lead to more consumption of carbon-based products derived from coal, natural gas, wood waste or other bio-mass materials and most importantly, more greenhouse gas is produced. There is thus a significant need in the art for energy and cost saving and environmentally friendly fuel cells.

Naoko Fujiwara et al. (Rapid evaluation of the electrooxidation of fuel compounds with a multiple-electrode setup for direct polymer electrolyte fuel cells. Journal of Power Source 164(2007) 457-463) reported the electrochemical oxidation of some fuel candidates in acidic media. Noble metals were used as electrocatalysts and membrane electrode assemblies (MEAs) were prepared to run the fuel cell when hypophosphorous acid and phosphorous acid were applied as one family of the fuel compounds.

JP2011-060531 disclosed a DFC, which is characterized by the use of hypophosphorous acid, hypophosphite, ammonia or their mixture as fuel and an ion conductive polymer as electrolyte. The use of inorganic fuels eliminates carbon consumption and CO₂ release in the atmosphere. On the other hand, since anion exchange membrane (AEM) is used instead of conventional sulfonic acid based proton exchange membrane (PEM), it becomes possible to avoid the using of precious electrode catalysts, such as Pt, Pd, Ir, Ru, Rh and Au. Cheap base metals, such as Ni, Ag, Co, Fe, Cu, Zn might also be considered. However, expensive anion exchange membrane is still inevitably used in this invention because “crossover” takes place without this highly resistive layer. Usually crossover leads to overpotential on cathodes, which reduce the cell performance, if the electrodes are not carefully designed. Moreover, the conductivity of such AEM is much lower than liquid electrolytes and PEM, which significantly hinders the performance of the fuel cells.

### INVENTION

In the view of problems in the prior art mentioned above, it is an objective of the present invention in particular to provide a fuel cell which directly uses oxidizable phosphorus compound, sulphur compound or nitrogen compound as fuel, notably a fuel cell without using ion-exchange membranes. The cheap cathode catalysts, no greenhouse gas emission make it possible to reduce the overall cost and more suitable for commercial production in comparison with fuel cells using precious metal catalysts and costly membranes. Moreover, fuel cell of present invention can solve the “crossover” problem by applying highly selective catalysts on both anode and cathode.

Other characteristics, details and advantages of the invention will emerge even more fully upon reading the description which follows.

### Definitions

Throughout the description, including the claims, the term “comprising one” should be understood as being synonymous with the term “comprising at least one”, unless otherwise specified, and “between” should be understood as being inclusive of the limits.

As used herein, the term “electrolyte” is an ion conducting medium that provides ionic conductivity between the anode and cathode portions of the fuel cell. The electrolyte medium may be any type of media that allows ionic conduction.

As used herein, the term “anode” means the electrode from which electrons migrate to the outside circuit and is the electrode where oxidation occurs.

As used herein, the term “cathode” means the electrode to which electrons migrate from the outside circuit and is the electrode where reduction occurs.

As used herein, the term “oxidizable compound” is a substance capable of being oxidized, or converted into an oxide.

As used herein, the term “metal complex” is a substance consisting of a central atom or ion, which is usually metallic and is called the coordination center, and a surrounding array of bound molecules or ions, that are in turn known as ligands or complexing agents.

As used herein, the term “metal alloy” is a metal alloy, which can be viewed as a solid metal-solid metal mixture wherein a primary metal acts as solvent while other metal(s) act(s) as solute; in a metal alloy and wherein the concentration of the metal solute does not exceed the limit of solubility of the metal solvent.

As used herein, the term “transition metals” refer to metals of group IB, IIB, IIIB, IVB, VB, VIB, VIM and VIIIB. This group comprises the elements with atomic number 21 to 30 (Sc to Zn), 39 to 48 (Y to Cd), 72 to 80 (Hf to Hg) and 104 to 112 (Rf to Cn).

As used herein, the term “Lanthanides” refer to metals with atomic number 57 to 71.

As used herein, the term “Actinides” refer to the metals with the atomic number 89 to 103.

As used herein, the term “alkyl group” includes saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups. The term “aliphatic group” includes organic moieties characterized by straight or branched-chains, typically having between 1 and 22 carbon atoms. In complex structures, the chains may be branched, bridged, or cross-linked. Aliphatic groups include alkyl groups, alkenyl groups, and alkynyl groups.

As used herein, the term “aryl group” includes unsaturated and aromatic cyclic hydrocarbons as well as unsaturated and aromatic heterocycles containing one or more rings. Aryl groups may also be fused or bridged with alicyclic or heterocyclic rings that are not aromatic so as to form a polycycle, such as tetralin. An “arylene” group is a divalent analog of an aryl group.

As used herein, the term “Ru+C” refers to a mixture of Ru black catalyst powder and active carbon.

Should the disclosure of any patents, patent applications, and publications which are incorporated herein by reference conflict with the description of present application to the extent that it may render a term unclear, the present description shall take precedence.

### BRIEF DESCRIPTION OF DRAWINGS

FIG. 1 is polarization curve of fuel cell assembled in Example 1 by using Ag/C as cathode catalyst and fiberglass as separator.

FIG. 2 is polarization curve of fuel cell assembled in Example 1 by using Ru+C as cathode catalyst and fiberglass as separator.

FIG. 3 is polarization curve of fuel cell assembled in Example 2 by using Ag/C as cathode catalyst and PE as separator.

FIG. 4 is polarization curve of fuel cell assembled in Example 3 by using Ru+C as cathode catalyst and fiberglass as separator.

FIG. 5 is polarization curve of fuel cell assembled in Example 3 by using pure Ru as cathode catalyst and fiberglass as separator.

FIG. 6 illustrates a membraneless direct-type fuel cell with a very small electrode distance in example 4. 1—bubbler, 2—PTFE cap, 3—glass frame of the cell, 4—electrodes, 4a—lead wire, 4b—substrate, 4c—free standing catalyst film.

FIG. 7 illustrates a membraneless direct-type fuel cell with a very big electrode distance in example 4. 1—bubbler, 2—PTFE cap, 3—glass frame of the cell, 4—electrodes, 4a—lead wire, 4b—substrate, 4c—free standing catalyst film.

FIG. 8 is polarization curve of fuel cell assembled in Example 4 by using Ru+C as cathode catalyst in a membraneless direct-type fuel cell with a very big electrode distance.

FIG. 9 is polarization curve of fuel cell assembled in Example 4 by using Ru+C as cathode catalyst in a membraneless direct-type fuel cell with a very small electrode distance.

FIG. 10 is polarization curve of fuel cell assembled in Example 4 by using Ag/C as cathode catalyst in a membraneless direct-type fuel cell with a very small electrode distance.

### DETAILS OF THE INVENTION

The present invention related to a membraneless direct-type fuel cell comprising:
(i) An anode configured and arranged for electro-oxidizing a reductant being oxidizable compound chosen in a group consisting of phosphorus compound, sulphur compound, nitrogen compound and any combination thereof,
(ii) A cathode configured and arranged for electro-reducing an oxidant,
(iii) A solvent,
(iv) Optionally electrolyte,

wherein the anode and cathode are spaced apart and the reductant and oxidant freely communicate between the anode and cathode.

In present invention, oxidizable phosphorus compound, sulphur compound, nitrogen compound might be inorganic or organic compound.

Oxidizable phosphorus compound of present invention might be hypophosphorous acid compound or phosphorous acid compound.

Hypophosphorous acid compound of the present invention may be hypophosphorous acid or its derivatives. Hypophosphorous acid derivatives of present invention may notably be salts of hypophosphorous acid.

Examples of hypophosphorous acid salts notably are:
Alkali metal salts, such as lithium hypophosphite (LiH₂PO₂), sodium hypophosphite (NaH₂PO₂), potassium hypophosphite (KH₂PO₂);
Alkaline earth metal salts, such as beryllium hypophosphite (Be(H₂PO₂)₂), magnesium hypophosphite (Mg(H₂PO₂)₂), calcium hypophosphite (C₄H₂PO₂)₂);
Ammonium hypophosphite (NH₄H₂PO₂).

Among these, lithium hypophosphite (LiH₂PO₂), sodium hypophosphite (NaH₂PO₂), potassium hypophosphite (KH₂PO₂) and ammonium hypophosphite (NH₄H₂PO₂) are particularly preferred.

Phosphorous acid compound of the present invention may be phosphorous acid or its derivatives. Phosphorous acid derivatives of present invention may be salts of phosphorous acid.

Examples of phosphorous acid salts notably are:
Alkali metal salts, such as lithium phosphite (Li₃PO₃), lithium hydrogen phosphite (Li₂HPO₃), lithium dihydrogen phosphite (LiH₂PO₃), sodium phosphite (Na₃PO₃), sodium hydrogen phosphite (Na₂HPO₃), sodium dihydrogen phosphite (NaH₂PO₃), potassium phosphite (K₃PO₃), potassium hydrogen phosphite (K₂HPO₃) and potassium dihydrogen phosphite (KH₂PO₃);
Alkaline earth metal salts, such as beryllium phosphite (Be₃(PO₃)₂), magnesium phosphite (Mg₃(PO₃)₂) and calcium phosphite (Ca₃(PO₃)₂);
Ammonium phosphite ((NH₄)₃PO₃).

Among these, lithium phosphite (Li₃PO₃), sodium phosphite (Na₃PO₃), potassium phosphite (K₃PO₃) and ammonium phosphite ((NH₄)₃PO₃) are particularly preferred.

Oxidizable sulphur compound of present invention may be sulphurous acid compound or thiosulfuric acid compound.

Sulphurous acid compound of the present invention may be sulphurous acid or its derivatives. Sulphurous acid derivatives of present invention may notably be sulphites.

Examples of sulphites notably are:
Alkali metal salts, such as lithium sulphite (Li₂SO₃), sodium sulphite (Na₂SO₃) and potassium sulphite (K₂SO₃);
Alkaline earth metal salts, such as beryllium sulphite (BeSO₃), magnesium sulphite (MgSO₃) and calcium sulphite (CaSO₃);
Ammonium sulphite ((NH₄)₂SO₃).

Among these, lithium sulphite (Li₂SO₃), sodium sulphite (Na₂SO₃), potassium sulphite (K₂SO₃) and ammonium sulphite ((NH₄)₂SO₃) are particularly preferred.

Thiosulfuric acid compound of the present invention may be thiosulfuric acid and its derivatives. Thiosulfuric acid derivatives of present invention may be thiosulfates.

Examples of thiosulfates notably are:
Alkali metal salts, such as lithium thiosulfate (Li₂S₂O₃), sodium thiosulfate (Na₂S₂O₃), potassium thiosulfate (K₂S₂O₃);
Alkaline earth metal salts, such as beryllium thiosulfate (BeS₂O₃), magnesium thiosulfate (MgS₂O₃), calcium thiosulfate (CaS₂O₃);
Ammonium thiosulfate ((NH₄)₂S₂O₃).

Among these, lithium thiosulfate (Li₂S₂O₃), sodium thiosulfate (Na₂S₂O₃), potassium thiosulfate (K₂S₂O₃) and ammonium thiosulfate ((NH₄)₂S₂O₃) are particularly preferred.

In present invention, oxidizable nitrogen compound might be nitrous compound or amine.

Nitrous compound of present invention may be nitrous acid or its derivatives. Nitrous acid derivatives of present invention may be salts of nitrous acid.

Example of nitrous acid salts notably are:
Alkali metal salts, such as lithium nitrite (LiNO₂), sodium nitrite (NaNO₂) and potassium nitrite (KNO₂);
Alkaline earth metal salts, such as beryllium nitrite (Be(NO₂)₂), magnesium nitrite (Mg(NO₂)₂) and calcium nitrite (Ca(NO₂)₂);
Ammonium nitrite (NH₄NO₂).

Among these, lithium nitrite (LiNO₂), sodium nitrite (NaNO₂), potassium nitrite (KNO₂) and ammonium nitrite (NH₄NO₂) are particularly preferred.

Amine of present invention may be ammonia or organic amine, such as alkylamines, arylamines. Among these, ammonia is particularly preferred.

It should be understood that fuel of the invention may include one or several compounds above mentioned, in which any molar ratio or weight ratio of combinations thereof are contemplated as included within the scope of the invention.

In present invention, the oxidant used in the fuel cell could be organic or inorganic oxidizing agent. Preferably, oxidant could be chosen in a group consisting of hydrogen peroxide, oxygen and air.

The solvent for dissolving the fuel is not particularly limited. Any suitable solvent, such as water and hydrophilic organic solvent could be used. Examples of hydrophilic organic solvent are alcohols, such as methanol, ethanol and propanol. It should be understood that the solvent mentioned above could be used independently or in the form of mixtures.

The concentration of fuel in solution is preferably comprised between 0.01 M and 12 M. In one embodiment, a saturated solution might be used.

In present invention, an electrolyte may be optionally added to the solution. The electrolyte medium may be alkaline or acidic in nature. Preferred electrolyte is alkali metal hydroxide, such as lithium hydroxide (LiOH), sodium hydroxide (NaOH) or potassium hydroxide (KOH), alkali metal bicarbonate, such as sodium bicarbonate (NaHCO₃) or potassium bicarbonate (KHCO₃), alkali metal carbonate, such as lithium carbonate (Li₂CO₃), sodium carbonate (Na₂CO₃) or potassium carbonate (K₂CO₃).

In one embodiment, additives might also been added to avoid competitive reaction or stabilize the fuel, such as thiourea, glycerol, etc. Said competitive reaction particularly refers to hydrogen evolution reaction, which is the production of hydrogen through the process of water electrolysis.

In present invention, electrode catalyst for anode or cathode may comprise metal element chosen in a group consisting of (i) Transition metals, (ii) Lanthanides, (iii) Actinides, (iv) Elements of Groups IA, IIA, IIIA, IVA, VA, VIA, VIIA of Periodic Table and (v) Any combination thereof.

Specifically, hydrogen is not included in metal element chosen in Group IA of the Periodic Table. Carbon is not included in metal element chosen in Group IVA of the Periodic Table. Nitrogen and phosphorus are not included in metal element chosen in Group VA of the Periodic Table. Oxygen, sulfur and selenium are not included in metal element chosen in Group VIA of the Periodic Table. Fluorine, chlorine, bromine and iodine are not included in metal element chosen in Group VIIA.

The metal elements for the purpose of the present invention are also referred to as metalloids. The term metalloid is generally designating an element which has properties between those of metals and non-metals. Typically, metalloids have a metallic appearance but are relatively brittle and have a moderate electrical conductivity. The six commonly recognized metalloids are boron, silicon, germanium, arsenic, antimony, and tellurium. Other elements also recognized as metalloids include aluminum, polonium, and astatine. On a standard periodic table all of these elements may be found in a diagonal region of the p-block, extending from boron at one end, to astatine at the other (as indicated above).

Electrode catalyst for anode or cathode of present invention may comprise metal element, which could be in the form of elemental metal, metal alloy, metal oxide or metal complex.

Electrode catalyst for anode or cathode of present invention comprising metal element may be metal oxide compounds comprising typically at least one oxygen atom and at least one metal atom which are chemically bound to the oxygen atom. The metal atom comprised in the metal oxide can be notably transition metal element, post transition metal element, rare earth metal element or metalloid element.

Examples of metal oxide compounds notably are:
Transition metal oxides, such as: titanium oxide (TiO₂), zinc oxide (ZnO), zirconium oxide (ZrO₂) and manganese oxide (MnO₂).
Post transition metal oxides, such as: aluminum oxide (Al₂O₃).
Rare earth element oxides, such as: cerium oxide (CeO₂), lanthanium oxide (La₂O₃), praseodymium oxide (Pr₆O₁₁), neodymium oxide (Nd₂O₃), yttrium oxide (Y₂O₃), ruthenium oxide (RuO₂), europium oxide (Eu₂O₃) and samarium oxide (Sm₂O₃).
Metalloid element oxides, such as: boron oxide (B₂O₃) and silicon oxide (SiO₂).
Perovskites, such as LaNiO₃, LaCoO₃.

The perovskite is any material with the same type of crystal structure as calcium titanium oxide (CaTiO₃), known as the perovskite structure, or ^{XII}A^{2+VI}B⁴⁺X²⁻₃ with the oxygen in the face centers, while A and B could also be more than one elements.

Electrode catalyst for anode or cathode of present invention comprising metal element may be metal alloy. The metal alloy may be notably selected from the group consisting of Pt—Au, Pd—Au, Pt—Pd, Pd—Ni, Pt—Ni, Pt—Ru, Pd—Ru and Pt—Sn alloys.

In one embodiment, catalyst for anode or cathode of present invention comprising metal element may further comprise non-metal elements, such as C, N and P. For example, non-metal element could be doped in the metal catalyst.

Electrode catalyst for anode or cathode of present invention may also comprise non-metal element chosen in a group consisting of elements of Groups IA, IVA, VA, VIA, VIIA of Periodic Table or any combination thereof. Said catalyst preferably comprises non-metal elements, such as C, N and P and combinations thereof. More preferable catalyst comprising of non-metal elements is N-doped C or S-doped C.

In present invention, anode catalyst may preferably comprise element chosen in a group consisting of elements of Groups IIIA, IVA, VA of Periodic Table and Transition metals.

Examples of anode catalyst notably are:
Elemental metal comprise element chosen in a group consisting of Pd, Pt, Ru, Au, Rh, Ir, Bi, Sn, B and any combination thereof.
Metal alloy, such as Pd—Au, Pd—B and Pt—Ru.

In present invention, cathode catalyst may preferably comprise element chosen in a group consisting of elements of Groups IA, IIA, IIIA, IVA, VA, VIA, VIIA of Periodic Table, Transition metals and Lanthanides.

Examples of cathode catalyst notably are:
Elemental metal comprise element chosen in a group consisting of Ag, Ni, Ru, Ir, Os, Mn, La, Co, Ce and any combination thereof
Metal oxide, such as manganese oxide (MnO₂), ruthenium oxide (RuO₂), cerium oxide (CeO), europium oxide (Eu₂O₃), samarium oxide (Sm₂O₃), cobalt dioxide (CoO), cobaltic oxide (Co₃O₄), Perovskites, such as LaNiO₃, LaCoO₃ and any combination thereof.
Non-metal compound, such as N-doped C and S-doped C.

Unlike conventional fuel cell as described in JP2011-060531, reaction of reductant with oxidant on a cathode (“crossover” phenomenon) should be avoided by the way of using cathode catalyst less active toward fuel oxidation and using electrolyte membranes to prevent the fuel penetration. In present invention, the reductant and oxidant can freely communicate between the anode and cathode without using electrolyte membranes. In one embodiment, based on total weight of reductant employed, at least 20 wt % reductants may contact the cathode. Preferably, at least 40 wt % reductants may contact the cathode; besides, based on total weight of oxidant employed, at least 20 wt % oxidants may contact the anode. Preferably, at least 40 wt % oxidants may contact the anode. In another embodiment, based on total weight of reductant employed, reductant contacts the cathode may be comprised between 20 wt % and 80 wt %, preferably between 30 wt % and 60 wt %; besides, based on total weight of oxidant employed, oxidant contacts the anode may be comprised between 20 wt % and 80 wt %, preferably between 30 wt % and 60 wt %.

It should be understand by the people skilled in the art that the electrode catalyst for anode or cathode mention above could be loaded on a support. The supports applied are not particularly limited. Typical example of supports could be carbon, alumina and silica.

In one embodiment, the electrode may comprise catalyst mentioned above and a substrate.

Preferably, the anode and cathode could be made with porous substrate structures. The anode substrates may comprise one or more conducting materials prepared in a sheet, foam, grid, cloth or other similar conductive and porous structure. The substrate can be chemically passive, and merely physically support the anode catalyst and transmit electrons, and/or it can be chemically or electrochemically active, assisting in the anode reaction, in pre-conditioning of fuel, in post-conditioning of anode reaction products, in physical control of the location of the electrolyte and other fluids, and/or in other similarly useful processes. Anode substrates can include, for example, stainless steel net, nickel foam, sintered nickel powder, etched aluminum-nickel mixtures, carbon fibers, and carbon cloth. Preferably, carbon materials and stainless steel are used as an anode substrate.

The cathode substrates may comprise one or more conducting materials prepared in a sheet, foam, grid, cloth or other similar structure. The cathode substrate can be chemically passive, and merely physically support the cathode catalyst and transmit electrons, and/or it can be chemically or electrochemically active, assisting in the cathode reaction, in pre-conditioning of fuel, in post-conditioning of cathode reaction products, in physical control of the location of the electrolyte and other fluids, and/or in other similarly useful processes. Cathode substrates can include stainless steel, nickel foam, sintered nickel powder, etched aluminum-nickel mixtures, metal screens, carbon fibers, and carbon cloth.

Methods for applying the anode catalysts to the anode substrate and cathode catalysts to the cathode substrate include, for example, spreading, wet spraying, powder deposition, electro-deposition, evaporative deposition, dry spraying, decaling, painting, sputtering, low pressure vapor deposition, electrochemical vapor deposition, tape casting, screen printing, hot pressing and other methods.

When electrode substrates are used, the preferred range of catalyst loading amount may be comprised between 0.01 and 500 mg/cm⁻². More preferably, the catalyst loading amount may be comprised between 1 and 20 mg/cm⁻².

In present invention, the distance between the two electrodes may be comprised between 0.1 cm and 10 cm and preferably between 0.2 cm and 2 cm. The structure of equipment applied to present invention is not particularly limited. In one preferred embodiment, the anode and cathode may reside in one compartment, in which reductant and oxidant exist in one solution and no separator is used.

In another preferred embodiment, anode and cathode reside in two independent apartments, where a separator could be placed between the two compartments. As used herein “separator” should be understood as a layer that provides a physical separation between the anode and the cathode and acts as an electrical insulator between the two conductive electrodes. It has pores big enough for the fuel or electrolyte solution to go through. In this equipment, reductant and oxidant might exist in two compartments. But it's still possible for reductant and oxidant freely to communicate between the anode and cathode.

The difference between separator and ion-exchange membrane is that it is not selective to ions and it allows fuel molecules to flow freely between the anode and the cathode. Because of this difference, the separator is much cheaper and much less resistive than the ion-exchange membrane.

The materials of separator are not particularly limited. Examples of separators include dielectric materials such as nonwoven fibers like cotton, nylon, polyesters, glass, polymer like polyethylene, polypropylene, poly(tetrafluoroethylene), polyvinyl chloride or naturally occurring substances like rubber, asbestos, wood.

Separators can consist of a single or multiple layers/sheets of same or different materials.

In one embodiment, the present invention is a fuel cell comprising an anode and a cathode made with substrates and porous separator. For example, anode and cathode made with substrates are pressed to each side of the separator so it makes an electrode assembly or separator can be only disposed between the anode and cathode.

The following examples are included to illustrate embodiments of the invention. Needless to say, the invention is not limited to the described examples.

### EXPERIMENTAL PART

### Example 1

In this example, Pd/C (30 wt %) was used as anode catalyst, while Ag/C (20 wt %) as well as Ru black (produced by Premetek Co.) was used as cathode catalyst.

Conventional fuel cell testing hardware manufactured by Hephas was used for fuel cell performance test. A fuel cell controlling module also from Hephas was used for controlling the flow rates of anode and cathode, as well as the cell temperature.

Pd/C (30 wt %) catalyst was synthesized through impregnation-reduction method with sodium borohydride (NaBH₄) as reducing agent. Typically, 0.60 g active carbon (Vulcan XC-72) was mixed with 0.428 g (2.41 mmol) PdCl₂ in 50 ml deionized water. The suspension was ultrasonicated for 30 minutes. 0.729 g (19.28 mmol) NaBH₄ was freshly dissolved in 10 ml deionized water and then added to the suspension drop by drop under vigor stirring. The mixture was further ultrasonicated for another 30 minutes. Finally, the product was filtered and washed by deionized water for 3 times. The washed catalyst was dried at 80° C. in vacuum overnight.

Ag/C (20 wt %) catalyst was synthesized through impregnation-reduction method with sodium borohydride (NaBH₄) as reducing agent. Typically, 0.60 g active carbon (Vulcan XC-72) was mixed with 0.236 g (1.39 mmol) AgNO₃ in 50 ml deionized water. The suspension was ultrasonicated for 30 minutes. 0.421 g (11.12 mmol) NaBH₄ was freshly dissolved in 10 ml deionized water and then added to the suspension drop by drop under vigorous stirring. The mixture was further ultrasonicated for another 30 minutes. Finally, the product was filtered and washed by deionized water for 3 times. The washed catalyst was dried at 80° C. in vacuum overnight.

Pd/C (30 wt %) anode was prepared by the following steps. 40 mg PTFE was dissolved in 200 ml water to get a 20 wt % PTFE aqueous solution. The catalyst powder 160 mg Pd/C (30 wt %) was mixed with 200 mg of the above prepared 20% PTFE aqueous solution to reach a metal catalyst to PTFE weight ratio of 4:1. The mixture was grinded and several drops of isopropyl alcohol were added until a dense paste was obtained. The paste was then rolled between two cylinders heated at 50° C. to obtain a free-standing catalyst film. The film was then dried at 50° C. and low pressure overnight. The dried film was cut into 2.25 cm² (1.5×1.5 cm), and pressed onto carbon paper (TGPH060, Toray) at 20 MPa to form anode. For Pd/C (30 wt %) catalyst, the final metal loading was 1.0 mg/cm², which was calculated by equation (1):

$$Metal loading = \frac{{W}_{film} \times {C}_{catalyst} \times {L}_{metal}}{{A}_{film}} \qquad ( 1 )$$

where
W_{film} weight of the free standing film
C_{catalyst} concentration of catalyst in the formulated paste
Lₘₑₜₐₗ metal loading in the catalyst powders
A_{film} area of the free standing film

Ag/C (20 wt %) cathode was prepared by the following steps. 40 mg PTFE was dissolved in 200 ml water to get a 20 wt % PTFE aqueous solution. The catalyst powder 160 mg Ag/C (20 wt %) was mixed with 200 mg of the above prepared 20% PTFE aqueous solution to reach a metal catalyst to PTFE weight ratio of 4:1. The mixture was grinded and several drops of isopropyl alcohol were added until a dense paste was obtained. The paste was then rolled between two cylinders heated at 50° C. to obtain a free-standing catalyst film. The film was then dried at 50° C. and low pressure overnight. The dried film was cut into 2.25 cm² (1.5×1.5 cm), and pressed onto Ni foam at 20 MPa to form cathode. For Ag/C (20 wt %) catalyst, the final metal loading was 2.4 mg/cm², which was calculated by equation (1).

Ru+C cathode was prepared by the following steps. 40 mg PTFE was dissolved in 200 ml water to get a 20 wt % PTFE aqueous solution. 160 mg Ru black catalyst powder and 160 mg active carbon was mixed with 200 mg of the above prepared 20% PTFE aqueous solution to reach a metal catalyst to PTFE weight ratio of 4:1. Active carbon could increase the conductivity of the layer and facilitate the preparation of the film. The ratio of Ru black to active carbon was 1:1 in weight. The mixture was grinded and several drops of isopropyl alcohol were added until a dense paste was obtained. The paste was then rolled between two cylinders heated at 50° C. to obtain a free-standing catalyst film. The film was then dried at 50° C. and low pressure overnight. Finally this catalyst film was cut into 2.25 cm² (1.5×1.5 cm), and pressed onto Ni foam to form cathode. For Ru black catalyst, the final metal loading was 4.5 mg/cm², which was calculated by equation (2):

$$Metal loading = \frac{{W}_{film} \times {C}_{catalyst}}{{A}_{film}} \qquad ( 2 )$$

where
W_{film} weight of the free standing film
C_{catalyst:} concentration of catalyst in the formulated paste
A_{film} area of the free standing film

The as-prepared cathode and anode were inserted in the fuel cell hardware and a piece of fiberglass was placed in between as a separator.

The anode fuel tested in this example was a solution of 0.5M NaH₂PO₂ and 1M KOH. The fuel was delivered to anode at a flow rate of 420 ml/hour. And air (1 bar) was supplied to cathode at 100 ml/min. The temperature of the cell was controlled at 28° C. by Hephas controlling module.

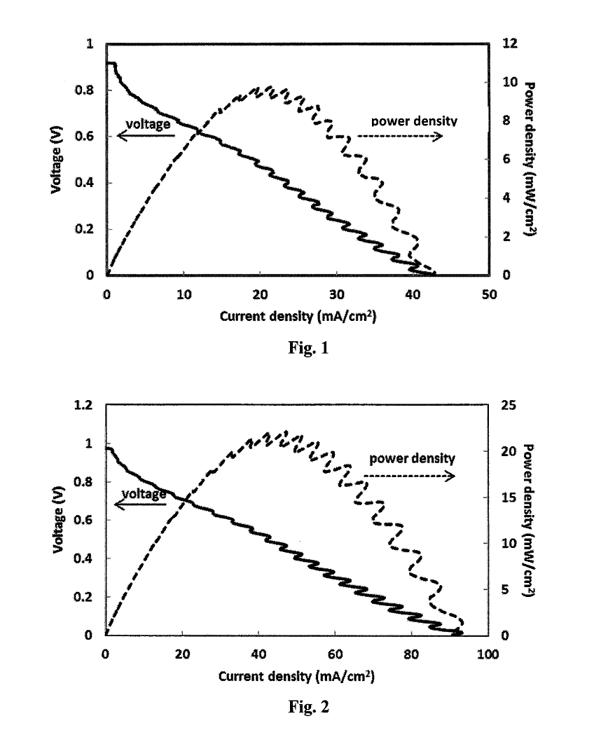

Polarization curves of the above assembled fuel cells using different cathode catalysts are shown in FIG. 1 and FIG. 2, while the related cell performances are summarized in Table 1.

TABLE 1
Parameters and performance of fuel cells assembled in Example 1

| | | | | | | | Power |
|---|---|---|---|---|---|---|---|
| | Loading | | Loading | | E_{oc} | Iₘₐₓ | density |
| Anode | (mg/cm²) | Cathode | (mg/cm²) | Separator | (V) | (mA/cm²) | (mW/cm²) |
| Pd/C (30%) | 1 | Ag/C (20%) | 2.4 | fiberglass | 0.92 | 42 | 9.8 |
| Pd/C (30%) | 1 | Ru + C | 4.5 | fiberglass | 0.97 | 90 | 22 |

### Example 2

In this example, Pd/C (20 wt %) and Ag/C (20 wt %) catalysts were prepared from the method described in EXAMPLE 1, and were used as anode and cathode catalysts respectively.

Pd/C (20 wt %) catalyst was synthesized through impregnation-reduction method with sodium borohydride (NaBH₄) as reducing agent. Typically, 0.60 g active carbon (Vulcan XC-72) was mixed with 0.250 g (1.41 mmol) PdCl₂ in 50 ml deionized water. The suspension was ultrasonicated for 30 minutes. 0.426 g (11.28 mmol) NaBH₄ was freshly dissolved in 10 ml deionized water and then added to the suspension drop by drop under vigor stirring. The mixture was further ultrasonicated for another 30 minutes. Finally, the product was filtered and washed by deionized water for 3 times. The washed catalyst was dried at 80° C. in vacuum overnight.

The anode and cathode were prepared by the same method as described in EXAMPLE 1, except for the replacement of fiber glass by PE (polyethylene) for separation purpose. The metal loadings on anode and cathode were calculated by equation (1).

All the testing conditions were the same as those described in EXAMPLE 1. Polarization curve of the assembled fuel cell using PE separator is shown in FIG. 3, and the related cell performances are summarized in Table 2.

TABLE 2
Parameters and performance of fuel cell assembled in Example 2

| | | | | | | | Power |
|---|---|---|---|---|---|---|---|
| | Loading | | Loading | | E_{oc} | Iₘₐₓ | density |
| Anode | (mg/cm²) | Cathode | (mg/cm²) | Separator | (V) | (mA/cm²) | (mW/cm²) |
| Pd/C (20%) | 1.2 | Ag/C (20%) | 2.4 | PE | 0.84 | 5.5 | 1.4 |

### Example 3

In this example, Pd/C (20 wt %) was prepared from the method described in EXAMPLE 2, while Ru black catalyst was purchased from Premetek Co. Pd/C (20 wt %) and Ru black were used as anode and cathode catalysts, respectively.

In this example, Pd/C (20 wt %) anode was prepared by the following steps. 40 mg PTFE was dissolved in 200 ml water to get a 20 wt % PTFE aqueous solution. The catalyst powder 160 mg Pd/C (20 wt %) was mixed with 200 mg of the above prepared 20% PTFE aqueous solution to reach a metal catalyst to PTFE weight ratio of 4:1. The mixture was grinded and several drops of isopropyl alcohol were added until a dense paste was obtained. The paste was then rolled between two cylinders heated at 50° C. to obtain a free-standing catalyst film. The film was then dried at 50° C. and low pressure overnight. The dried film was cut into 2.25 cm² (1.5×1.5 cm), and pressed onto fiber glass at 20 MPa to form the anode. The final metal loading was calculated from the equation (1) described in EXAMPLE 1.

To study the influence of active carbon on the cell performance, Pure Ru cathode, as well as Ru+C cathode, was prepared respectively. Ru+C cathode was prepared according to the method described in EXAMPLE 1 with Ni foam and GDL as substrate while pure Ru electrode was prepared from the method described below. 40 mg PTFE was dissolved in 200 ml water to get a 20 wt % PTFE aqueous solution. 160 mg Ru black catalyst powder was mixed with 200 mg of the above prepared 20% PTFE aqueous solution to reach a metal catalyst to PTFE weight ratio of 4:1. The mixture was grinded and several drops of isopropyl alcohol were added until a dense paste was obtained. The paste was then rolled between two cylinders heated at 50° C. to obtain a free-standing catalyst film. The film was then dried at 50° C. and low pressure overnight. Finally this catalyst film was cut into 2.25 cm² (1.5×1.5 cm) and pressed onto Ni foam and GDL (Gas Diffusion Layer) to form the pure Ru cathode. The final metal loading was calculated from equation (2).

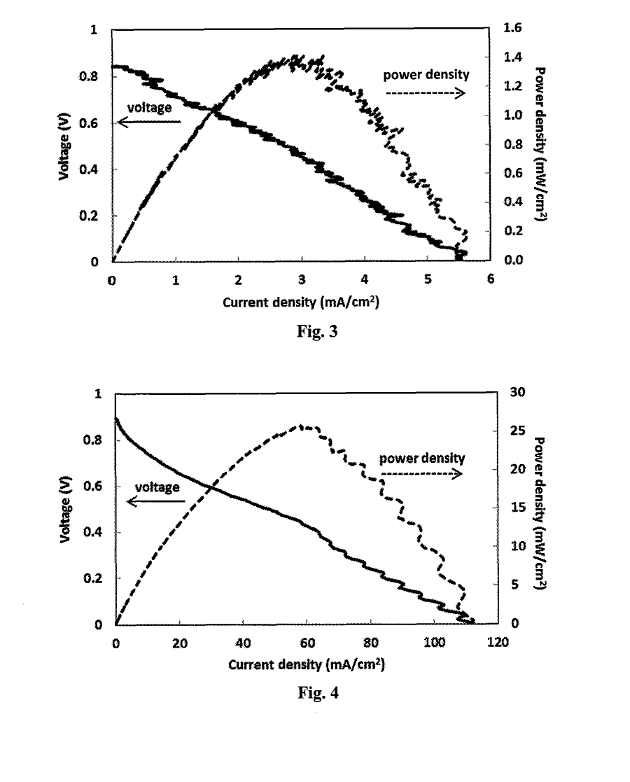

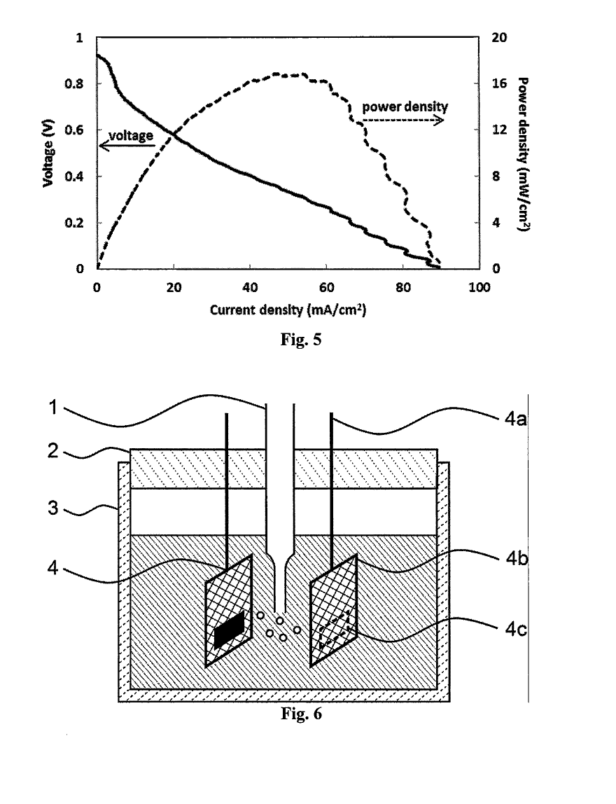

All the testing conditions were the same as those described in EXAMPLE 1. Polarization curves of the assembled fuel cells are shown in FIGS. 4 and 5, while the related cell performances are summarized in Table 3.

TABLE 3
Parameters and performance of fuel cells assembled in Example 3

| | | | | | | | Power |
|---|---|---|---|---|---|---|---|
| | Loading | | Loading | | E_{oc} | Iₘₐₓ | density |
| Anode | (mg/cm²) | Cathode | (mg/cm²) | Separator | (V) | (mA/cm²) | (mW/cm²) |
| Pd/C (20%) | 3.4 | Ru + C | 3 | fiberglass | 0.9 | 114 | 25.9 |
| Pd/C (20%) | 3.4 | Ru | 13 | fiberglass | 0.91 | 92 | 16.8 |

### Example 4

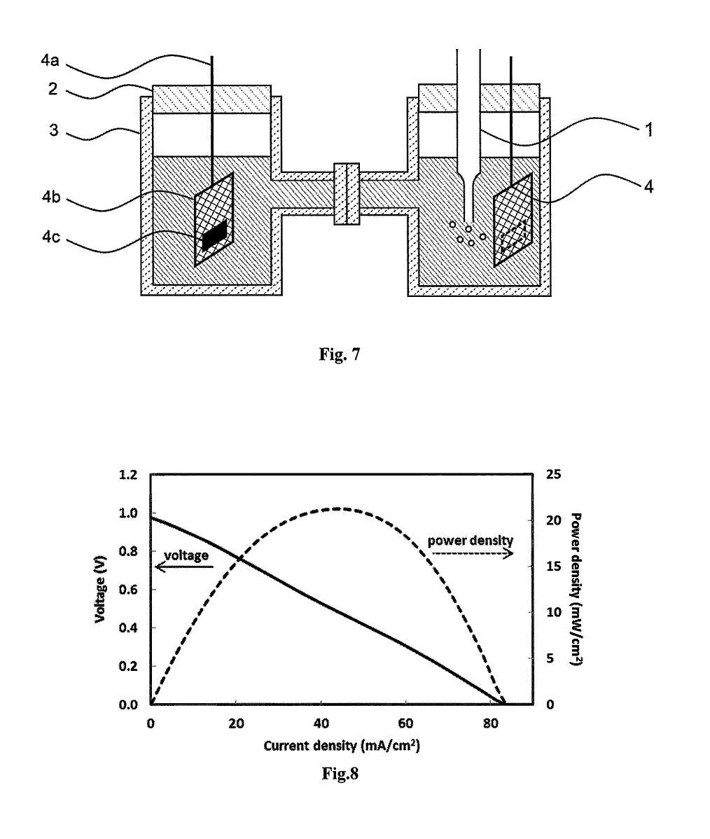

In this example, fuel cell performances were tested in membrane-less cells. A standard electrochemical cell was used to demonstrate a fuel cell with a very small electrode distance, as illustrated in Figure. 6. An H-shaped cell is also used to demonstrate a fuel cell in widely separated electrodes setting as illustrated in Figure. 7.

In this example, Pd/C (20 wt %) and Ag/C (20 wt %) was prepared from the method described in EXAMPLE 2 and EXAMPLE 1, respectively, while Ru black catalyst was purchased from Premetek Co. Pd/C (20 wt %) was used for anode catalyst, while Ag/C (20 wt %) and Ru black was used as cathode catalysts.

Pd/C (20 wt %) anode was prepared from a similar method as that described in EXAMPLE 3. 40 mg PTFE was dissolved in 200 ml water to get a 20 wt % PTFE aqueous solution. The catalyst powder 160 mg Pd/C (20 wt %) was mixed with 200 mg of the above prepared 20% PTFE aqueous solution to reach a metal catalyst to PTFE weight ratio of 4:1. The mixture was grinded and several drops of isopropyl alcohol were added until a dense paste was obtained. The paste was then rolled between two cylinders heated at 50° C. to obtain a free-standing catalyst film. The film was then dried at 50° C. and low pressure overnight. The dried film was cut into 0.32 cm² (0.4×0.8 cm), and pressed onto a stainless steel grid at 20 MPa to form the anode. The final metal loading was calculated from equation (1) described in EXAMPLE 1.

Ag/C (20 wt %) cathode was prepared by a similar method described in EXAMPLE 1. 40 mg PTFE was dissolved in 200 ml water to get a 20 wt % PTFE aqueous solution. The catalyst powder 160 mg Ag/C (20 wt %) was mixed with 200 mg of the above prepared 20% PTFE aqueous solution to reach a metal catalyst to PTFE weight ratio of 4:1. The mixture was grinded and several drops of isopropyl alcohol were added until a dense paste was obtained. The paste was then rolled between two cylinders heated at 50° C. to obtain a free-standing catalyst film. The film was then dried at 50° C. and low pressure overnight. The dried film was cut into 1 cm² (1.0×1.0 cm), and pressed onto stainless steel grid at 20 MPa to form cathode. The final metal loading was calculated from equation (1).

Ru+C cathode was prepared from the method described in EXAMPLE 1. 40 mg PTFE was dissolved in 200 ml water to get a 20 wt % PTFE aqueous solution. 160 mg Ru black catalyst powder and 160 mg active carbon was mixed with 200 mg of the above prepared 20% PTFE aqueous solution to reach a metal catalyst to PTFE weight ratio of 4:1. Active carbon could increase the conductivity of the layer and facilitate the preparation of the film. The ratio of Ru black to active carbon was 1:1 in weight. The mixture was grinded and several drops of isopropyl alcohol were added until a dense paste was obtained. The paste was then rolled between two cylinders heated at 50° C. to obtain a free-standing catalyst film. The film was then dried at 50° C. and low pressure overnight. Finally this catalyst film was cut into 1 cm² (1.0×1.0 cm), and pressed onto stainless steel grid to form cathode. The final metal loading was calculated by equation (2).

For fuel cell performance test, anode and cathode were placed and fixed in the testing cells as illustrated in FIG. 6 and FIG. 7. In the standard electrochemical cell, the distance between anode and cathode is typically 1 cm, while the distance between anode and cathode is 5 cm in the H-shaped cell.

For the test in membrane-less cells, aqueous fuel, which consists of 0.5 M NaH₂PO₂ and 1 M KOH, was poured into the testing cells, while oxygen was bubbled before the test to reach gas saturation and was kept bubbling through the whole test toward the cathode. The test was performed at room temperature, around 25° C.

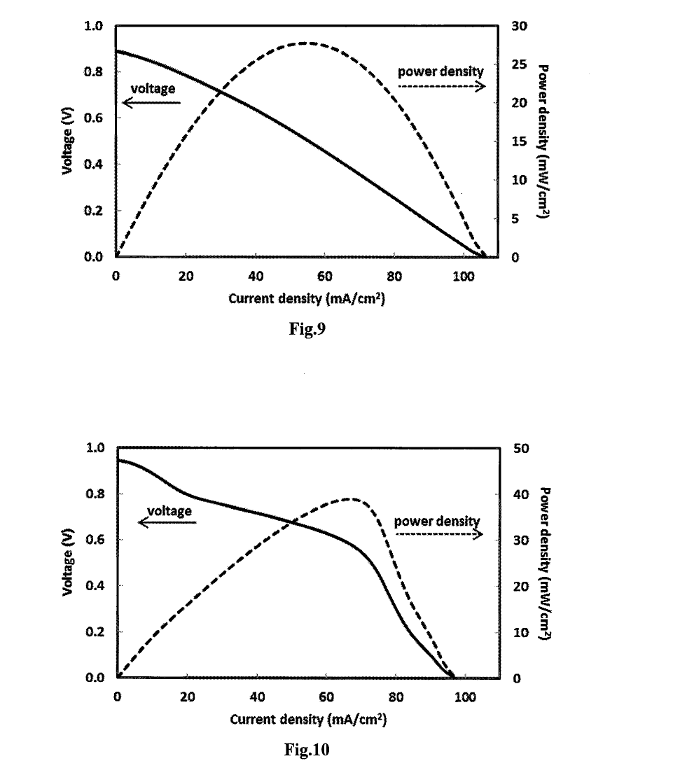

Polarization curves of the assembled fuel cells in this example are shown in FIGS. 8, 9 and 10, while the related cell performances are summarized in Table 4.

TABLE 4
Parameters and performance of fuel cells assembled in Example 4

| | | | | Cell/ | | | Power |
|---|---|---|---|---|---|---|---|
| | Loading | | Loading | electrodes | E_{oc} | Iₘₐₓ | density |
| Anode | (mg/cm²) | Cathode | (mg/cm²) | distance | (V) | (mA/cm²) | (mW/cm²) |
| Pd/C (20%) | 2.25 | Ru + C | 3.2 | H-shaped | 0.97 | 85 | 21.2 |
| | | | | cell/5 cm | | | |
| Pd/C (20%) | 2.25 | Ru + C | 3.2 | Standard | 0.89 | 106 | 27.7 |
| | | | | cell/1 cm | | | |
| Pd/C (20%) | 2.25 | Ag/C (20%) | 1.92 | Standard | 0.94 | 97 | 38.8 |
| | | | | cell/1 cm | | | |

1. A membraneless direct-type fuel cell comprising:
(i) An anode configured and arranged for electro-oxidizing a reductant being an oxidizable compound selected from a group consisting of phosphorus compound, sulphur compound, nitrogen compound and any combination thereof,
(ii) A cathode configured and arranged for electro-reducing an oxidant,
(iii) A solvent,
(iv) Optionally an electrolyte,
wherein the anode and cathode are spaced apart and the reductant and oxidant freely communicate between the anode and cathode.

2. The fuel cell according to claim 1, wherein the oxidizable phosphorus compound is hypophosphorous acid compound or phosphorous acid compound.

3. The fuel cell according to claim 2, wherein the hypophosphorous acid compound is selected from a group consisting of hypophosphorous acid, its alkali metal salts, its alkaline earth metal salts, its ammonium salt and any combination thereof; or wherein the phosphorous acid compound is selected from a group consisting of phosphorous acid, its alkali metal salts, its alkaline earth metal salts, its ammonium salt and any combination thereof.

4. (canceled)

5. The fuel cell according to claim 1, wherein the oxidizable sulphur compound is sulphurous acid compound or thiosulfuric acid compound.

6. The fuel cell according to claim 5, wherein the sulphurous acid compound is selected from a group consisting of sulphurous acid, its alkali metal salts, its alkaline earth metal salts, its ammonium salt and any combination thereof; or wherein the thiosulfuric acid compound is selected from a group consisting of thiosulfuric acid, its alkali metal salts, its alkaline earth metal salts, its ammonium salt and any combination thereof.

7. (canceled)

8. The fuel cell according to claim 1, wherein the oxidizable nitrogen compound is an amine or is selected from a group consisting of nitrous acid, its alkali metal salts, its alkaline earth metal salts, its ammonium salt and any combination thereof.

9. (canceled)

10. The fuel cell according to claim 1, wherein electrode catalyst for anode or cathode comprises metal element selected from a group consisting of (i) Transition metals, (ii) Lanthanides, (iii) Actinides, (iv) Elements of Groups IA, IIA, IIIA, IVA, VA, VIA, VIIA of Periodic Table and (v) Any combination thereof; or comprises non-metal element selected from a group consisting of elements of Groups IA, IVA, VA, VIA, VIIA of Periodic Table and any combination thereof.

11. The fuel cell according to claim 10, wherein the metal element comprised in anode or cathode is in the form of elemental metal, metal alloy, metal oxide or metal complex.

12. (canceled)

13. The fuel cell according to claim 1, wherein anode catalyst comprises an element selected from a group consisting of elements of Groups IIIA, IVA, VA of Periodic Table and Transition metals.

14. The fuel cell according to claim 1, wherein anode catalyst comprises an element selected from a group consisting of Pd, Pt, Ru, Ir, Au, Rh, Bi, B or Sn and any combination thereof.

15. The fuel cell according to claim 1, wherein cathode catalyst comprises an element selected from a group consisting of elements of Groups IA, IIA, IIIA, IVA, VA, VIA, VIIA of Periodic Table, Transition metals and Lanthanides.

16. The fuel cell according to claim 1, wherein cathode catalyst comprises an element selected from a group consisting of Ag, Ni, Ru, Ir, Os, Mn, La, Co, Ce and any combination thereof; or comprises oxide selected from a group consisting of MnO₂, RuO₂, CeO₂, Eu₂O₃, Sm₂O₃, CoO, Co₃O₄, LaNiO₃, LaCoO₃ and any combination thereof.

17. (canceled)

18. The fuel cell according to claim 1, wherein at least 20 wt % reductant contact the cathode based on total weight of reductant employed or wherein at least 20 wt % oxidant contact the cathode based on total weight of oxidant employed.

19. The fuel cell according to claim 18, wherein reductant contacting the cathode is comprised between 20 wt % and 80 wt % based on total weight of reductant employed or wherein oxidant contacting the cathode is comprised between 20 wt % and 80 wt % based on total weight of oxidant employed.

20. (canceled)

21. (canceled)

22. The fuel cell according to claim 1, wherein the concentration of reductant in solution is preferably comprised between 0.01 M and 12 M.

23. The fuel cell according to claim 1, wherein electrode catalyst is applied to a support.

24. The fuel cell according to claim 1, wherein the loading of electrode catalyst on substrate is comprised between 0.01 and 500 mg/cm⁻².

25. The fuel cell according to claim 1, wherein the distance between the two electrodes is comprised between 0.1 cm and 10 cm.

26. The fuel cell according to claim 1, wherein a separator is placed between the anode and cathode.

27. The fuel cell according to claim 26, wherein the separator is selected from a group consisting of fibers, polymers and naturally occurring substances.
